(19) United States
(12) Patent Application Publication
(10) Pub. No.: US 2026/0187139 A1
(43) Pub. Date: Jul. 2, 2026

(54) PLUG-AND-PLAY EMBEDDING ENHANCMENT IN VECTOR DATABASES FOR RETRIEVAL-BASED APPLICATIONS

(71) Applicant: Robert Bosch GmbH, Stuttgart (DE)

(72) Inventors: Xin Li, Sunnyvale, CA (US); Clint Sebastian, Stuttgart (DE); Frederik Zilly, Stuttgart (DE); Wenbin He, Santa Clara, CA (US); Liu Ren, Saratoga, CA (US)

(21) Appl. No.: 19/413,521

(22) Filed: Dec. 9, 2025

Related U.S. Application Data
(60) Provisional application No. 63/740,802, filed on Dec. 31, 2024.

(51) Int. Cl. G06F 16/53; G06F 16/51; G06F 16/55; G06V 10/762; G06V 10/774

(52) U.S. Cl. CPC G06F 16/53; G06F 16/51; G06F 16/55; G06V 10/762; G06V 10/774

(57) ABSTRACT

A computer-implemented method and system relate to digital image retrieval and data curation. The data curation may relate to training a machine learning model on at least one specific task. A vocabulary of visual concepts is generated for a specific task using a target dataset. The vocabulary includes a representative image embedding for each visual concept. Precomputed image embeddings are retrieved from a vector database. Each precomputed image embedding is decomposed into a linear combination of the visual concepts. For each precomputed image embedding, a set of weights is generated based on the vocabulary. Each weight is indicative of a prominence of a respective representative image embedding. The set of weights of each precomputed image embedding is stored in an enhanced vector database. A set of digital images is retrievable from the enhanced vector database in response to a query.

### CROSS-REFERENCE TO RELATED APPLICATION

This patent application claims the benefit of U.S. Provisional Patent Application No. 63/740,802, which was filed on Dec. 31, 2024, and which is hereby incorporated herein by reference in its entirety.

### TECHNICAL FIELD

This disclosure relates generally to digital data processing, and more particularly to systems and methods for enhancing vector databases used in retrieval-based applications, and generating curated datasets from retrieved digital image data for training machine learning models.

### BACKGROUND

Vector databases, which transform unstructured data into semantically rich embeddings, enable various retrieval-based applications (e.g., retrieval augmented generation and data curation) that are crucial for Foundation Model (FM) training and deployment. However, the embeddings are often precomputed using FMs that are not optimized for specific downstream retrieval applications. For instance, some image retrievals using embeddings generated from the contrastive language-image pretraining (CLIP) encoder may result in the retrieval of irrelevant images that miss one or more objects of interest due to other shared background elements.

### SUMMARY

The following is a summary of certain embodiments described in detail below. The described aspects are presented merely to provide the reader with a brief summary of these certain embodiments and the description of these aspects is not intended to limit the scope of this disclosure. Indeed, this disclosure may encompass a variety of aspects that may not be explicitly set forth below.

According to at least one aspect, a computer-implemented method relates to digital image retrieval. According to at least one aspect, the computer-implemented method may further relate to using the digital image retrieval to generate curated datasets for training a machine learning model. The method includes generating a vocabulary of visual concepts for a specific task using a target dataset. The vocabulary includes a representative image embedding or a representative patch embedding for each visual concept. The method includes retrieving precomputed image embeddings from a vector database. The method includes decomposing each precomputed image embedding into a linear combination of the visual concepts. The method includes generating a set of weights for each precomputed image embedding based on the vocabulary. Each weight is indicative of a prominence of a respective representative image embedding or a respective representative patch embedding. The method includes storing the set of weights for each precomputed image embedding in an enhanced vector database. The method includes retrieving a set of digital images in response to a query using the enhanced vector database. As an example, the set of digital images is used to create a curated dataset for training the machine learning model, such as a classifier.

According to at least one aspect, a system includes one or more processors and one or more computer memory. The one or more computer memory are in data communication with the one or more processors. The one or more computer memory have computer readable data stored thereon. The computer readable data include instructions that, when executed by one or more processors, causes the one or more processors to perform a method for digital image retrieval. According to at least one aspect, the method may further relate to using the digital image retrieval to generate curated datasets for training a machine learning model. The method includes generating a vocabulary of visual concepts for a specific task using a target dataset. The vocabulary includes a representative image embedding or a representative patch embedding for each visual concept. The method includes retrieving precomputed image embeddings from a vector database. The method includes decomposing each precomputed image embedding into a linear combination of the visual concepts. The method includes generating a set of weights for each precomputed image embedding based on the vocabulary. Each weight indicating a prominence of a respective representative image embedding or a respective representative patch embedding. The method includes storing the set of weights for each precomputed image embedding in an enhanced vector database. The method includes retrieving a set of digital images in response to a query using the enhanced vector database. As an example, the set of digital images is used to create a curated dataset for training the machine learning model, such as a classifier.

These and other features, aspects, and advantages of the present invention are discussed in the following detailed description in accordance with the accompanying drawings throughout which like characters represent similar or like parts. Furthermore, the drawings are not necessarily to scale, as some features could be exaggerated or minimized to show details of particular components.

### BRIEF DESCRIPTION OF THE FIGURES

FIG. 1 is a diagram of an example of a process associated a plug-and-play embedding enhancement for retrieval-based applications (PERA) system according to an example embodiment of this disclosure.

FIG. 2 is a diagram that shows an example that compares an image retrieval result using PERA and an image retrieval result using a vector database according to an example embodiment of this disclosure.

FIG. 3 illustrates a first example of image retrieval results using image embeddings and image retrieval results using PERA according to an example embodiment of this disclosure.

FIG. 4 illustrates a second example of image retrieval results using image embeddings and image retrieval results using PERA according to an example embodiment of this disclosure.

FIG. 5 illustrates a second example of image retrieval results using image embeddings and image retrieval results using PERA according to an example embodiment of this disclosure.

FIG. 6 illustrates a first example of an application of PERA according to an example embodiment of this disclosure.

FIG. 7 illustrates a second example of an application of PERA according to an example embodiment of this disclosure.

FIG. 8 illustrates an example of a system that includes PERA according to an example embodiment of this disclosure.

FIG. 9 depicts a schematic diagram of an interaction between a computer-controlled machine and a control system according to an example embodiment of this disclosure.

FIG. 10 depicts a schematic diagram of the control system of FIG. 9 that is configured to control a mobile machine, which is at least partially or fully autonomous, according to an example embodiment of this disclosure.

FIG. 11 depicts a schematic diagram of the control system of FIG. 9 that is configured to control a manufacturing machine of a manufacturing system, such as part of a production line, according to an example embodiment of this disclosure.

FIG. 12 depicts a schematic diagram of the control system of FIG. 9 that is configured to control a monitoring system according to an example embodiment of this disclosure.

FIG. 13 depicts a schematic diagram of the control system of FIG. 9 that is configured to control a medical imaging system according to an example embodiment of this disclosure.

### DETAILED DESCRIPTION

The embodiments described herein, which have been shown and described by way of example, and many of their advantages will be understood by the foregoing description, and it will be apparent that various changes can be made in the form, construction, and arrangement of the components without departing from the disclosed subject matter or without sacrificing one or more of its advantages. Indeed, the described forms of these embodiments are merely explanatory. These embodiments are susceptible to various modifications and alternative forms, and the following claims are intended to encompass and include such changes and not be limited to the particular forms disclosed, but rather to cover all modifications, equivalents, and alternatives falling with the spirit and scope of this disclosure.

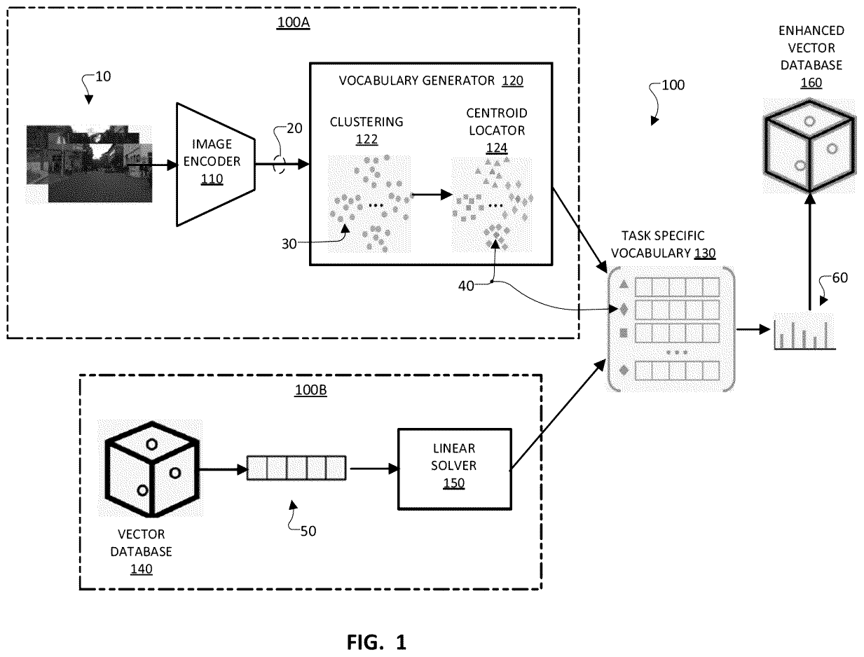

FIG. 1 illustrates an example of an overview of a process associated with Plug-and-play Embedding enhancement for Retrieval-based Applications (PERA) 100. PERA 100 enhances the embeddings 50 stored in a vector database 140 to improve the performance of retrieval-based applications. PERA 100 includes a novel method that enhances the performance of retrieval applications without recomputing application-specific embeddings. Specifically, PERA 100 enhances the precomputed embeddings 50 of a vector database 140 by decomposing them into a linear combination of embeddings tailored to a downstream application, which is computationally efficient. For each precomputed embedding 50, the process includes generating a set of weights 60 based on the vocabulary 130. Each set of weights 60 is then stored in the enhanced vector database 160. Finally, the process includes utilizing these decomposed sparse weights along with the Dice Coefficient for a similarity search via the enhanced vector database 160 to enhance the performance of the downstream task.

For a given retrieval application, the process includes vocabulary generation 100A. Vocabulary generation 100A includes constructing a dictionary of embeddings for that retrieval application. The dictionary of embeddings is referred to herein as a task-specific vocabulary 130. Specifically, a task-specific vocabulary 130, D, is constructed from the target dataset 10, Dr. For example, as shown in FIG. 1, the process includes generating, via an image encoder 110, image embeddings 20 based on pixels of digital images from the target dataset 10. Also, the process includes a vocabulary generator 120, which is configured to generate task specific vocabulary 130 of visual concepts based on the image embeddings 20. The task-specific vocabulary 130 contains a set of representative embeddings tailored to the downstream task. Each representative embedding relates to a visual concept. This process includes a strategy, which involves selecting embeddings that are both representative and diverse enough to cover the target dataset 10 comprehensively. For object-centric tasks such as instance search and retrieval augmented classification, the process uses embeddings of images from the target dataset 10, DT. For dense recognition tasks that involve multiple objects per image, the process employs patch-level embeddings. Also, the vocabulary generator 120 is configured to cluster these embeddings into clusters 30 and select a centroid 40 from each cluster 30 to form the task-specific vocabulary 130. This approach considers both representativeness and diversity, balancing the trade-off between retrieval speed and memory requirements versus performance.

To build the task-specific vocabulary 130, the process employs slightly different strategies for different tasks. For an instance search, when the query dataset is usually small (around 90 images), DBSCAN may be utilized to automatically identify the number of clusters. Conversely, for dense recognition, where the number of extracted embeddings from the target dataset can be large, the process may include using k-means clustering and setting the number of clusters to 500. For retrieval augmented classification, designed to address long-tail problems where few-shot classes may contain only 5 images, a direct clustering may overlook these few-shot classes. Thus, the process may include using the centroid 40 of embeddings for each class as our vocabulary. For the hyperparameter settings in Alternating Direction Method of Multipliers (ADMM), the process includes setting the maximum number of iterations k to be 2000, and the penalty values of τ and λ are set to 0.2 and 0.01, respectively.

In addition, the process includes sparse decomposition 100B. For example, as shown in FIG. 1, the process includes decomposing the embeddings 50 in vector database 140, Vₛ, via linear solver 150 according to the task-specific vocabulary 130. When decomposing embeddings, the process considers two key features: sparsity and nonnegativity. In general, a sparse and nonnegative combination of embeddings is easier to understand, whereas the presence of negative values in semantics is often less intuitive and harder to interpret. This motivates the optimization problem: reconstruct an embedding with a sparse, nonnegative combination of the representative embeddings from the task-specific vocabulary 130. Given the task-specific vocabulary 130, D, and an embedding, v, the sparse decomposition can be obtained by minimizing the l₀ norm with the constraint of exact reconstruction via equation 1, where “subject to” is denoted as “s.t.” and w represents the weight.

$${min}_{w ∈ {ℝ}_{+}^{D}} {‖ w ‖}_{0} s . t . v = Dw \qquad [ 1 ]$$

Since l₀ norm minimization is a nondeterministic polynomial time (NP) hard problem, the l₀ norm is replaced with the l₁ norm. The l₁ norm has been proven to also yield highly sparse solutions and has the advantage of being computationally more feasible due to its convexity, as demonstrated via equation 2. The linearity of w enables each weight of a set of weights 60 to be interpreted as the significance or prominence of the corresponding embedding in the task specific vocabulary 130. The sparse weight, w, then serves as a basis for similarity search in retrieval applications.

$${min}_{w ∈ {ℝ}_{+}^{D}} {‖ Dw - v ‖}_{2}^{2} + λ {‖ w ‖}_{1} = Dw \qquad [ 2 ]$$

As discussed above, sparse decomposition 100B includes decomposing precomputed embeddings 50, which are obtained from one or more vector databases 140. Specifically, the embeddings 50 are decomposed, via linear solver 150, into a linear combination of the embeddings from the dictionary (e.g., task specific vocabulary 130). The precomputed embeddings 50 are decomposed into sparse, non-negative combinations of the task-specific vocabulary 130. Also, the process includes storing each set of weights in the enhanced vector database 160 and using the decomposed sparse weights for the retrieval application to achieve better performance. Using this approach, the process enhances the precomputed embeddings 50 with a lightweight decomposition method that balances computational cost and performance for downstream applications.

In addition, the process includes performing a similarity search. While cosine similarity is a widely used measure to compute the similarity between two embeddings in a vector database, this approach is inappropriate for PERA 100. Specifically, in the context of PERA 100, which decomposes image embeddings and uses weights to represent the presence, significance, and/or prominence of certain vocabulary, cosine similarity might not adequately capture the nuanced overlap between the weights, w. To address this limitation, the process employs the Dice Coefficient, as expressed in equation 3. The Dice Coefficient specifically quantifies the overlap between two sets, making it sensitive to the overlap of the weights. By using the Dice Coefficient for similarity search, the process ensures that the retrieval process prioritizes instances that have significant semantic overlap with the query instance, focusing on the presence of critical vocabulary rather than the overall semantic information.

$$Dice ( {w}_{i} , {w}_{j} ) = 2 \vert {w}_{i} ⋂ {w}_{j} \vert / ( \vert {w}_{i} \vert + \vert {w}_{j} \vert ) \qquad [ 3 ]$$

Furthermore, the process may include scaling up with graphics processing unit (GPU) acceleration. Although the above optimization problem can be directly solved using widely used libraries such as Scikit-learn on a central processing unit (CPU), GPU acceleration becomes necessary for large vector databases with millions of instances. Thus, the process includes implementing the Alternating Direction Method of Multipliers (ADMM) algorithm in PyTorch with GPU support for efficient decomposition. To apply ADMM to this task, equation 2 is rewritten as equation 4. Then the Lagrangian with penalty parameter 1/τ>0 for equation 4 is defined by equation 5.

$${min}_{w ∈ {ℝ}_{+}^{D}} ‖ D w - v {‖}_{2}^{2} + λ ‖ z {‖}_{1} s . t . w - z = 0 \qquad [ 4 ]$$

$${ℒ}_{1} / τ ( w , z , y ) = \frac{1}{2} {‖ Dw - v ‖}_{2}^{2} + λ {‖ z ‖}_{1} + \frac{1}{τ} 〈 y , w - z 〉 + \frac{1}{2 τ} {‖ w - z ‖}_{2}^{2} \qquad [ 5 ]$$

With both zₖ₋₁, yₖ₋₁ fixed, the update of w is computed via equation 6. Also, zₖ is computed via equation 7, where S_{στ} is the term-by-term soft-thresholding operator. Furthermore, the dual update rule is computed via equation 8.

$${w}_{k} = {argmin}_{w} {ℒ}_{1} / τ ( w , {z}_{k - 1} , {y}_{k - 1} ) = {( {D}^{T} D + \frac{1}{τ} I )}^{- 1} ( {D}^{T} v + \frac{1}{τ} ( {z}_{k - 1} - {y}_{k - 1} ) ) \qquad [ 6 ]$$

$${z}_{k} = {argmin}_{z} {ℒ}_{1} / τ ( {w}_{k} , z , {y}_{k - 1} ) = {argmin}_{z} \{ \frac{1}{2 τ} {‖ {w}_{k} - {y}_{k - 1} - z ‖}_{2}^{2} + λ {‖ z ‖}_{1} \} = {S}_{λτ} ( {w}_{k} + {y}_{k - 1} ) \qquad [ 7 ]$$

$${y}_{k} = {y}_{k - 1} + 1 / τ ( {w}_{k} - {z}_{k} ) \qquad [ 8 ]$$

As indicated above, the steps outlined in Equations 6, 7, and 8 can be executed efficiently. In practice, the process iterates until convergence or reaches the maximum number of iterations that is set to 2000. A single GPU can efficiently handle the decomposition of approximately 2000 embeddings per second, which is around 50 times faster than extracting new embedding with FM using the same hardware.

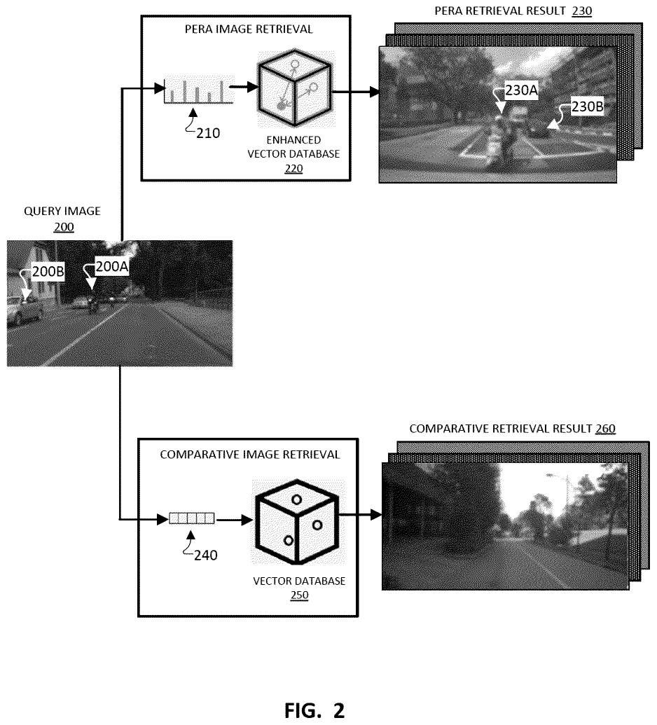

FIG. 2 shows the benefits of PERA image retrieval over comparative image retrieval with respect to a given query image 200. Specifically, the query image 200 is a digital image that displays a road, a sidewalk, trees, and a building. The road has two lanes. In addition, the query image 200 displays a front side of some cars 200B parked on one side of the road while also displaying at least one motorcycle 200A traveling on that same side of the road. The query image 200 is then used as a query to obtain (i) PERA retrieval result 230 using a set of weights 210 and an enhanced vector database 220 and (ii) comparative retrieval result 260 using an image embedding and a vector database 250.

The process, associated with PERA image retrieval, includes generating, via an image encoder, an image embedding, using pixels of the query image 200. The image embedding is decomposed into a linear combination of visual concepts of a task specific vocabulary. A set of weights 210 is generated based on the task specific vocabulary. The set of weights 210 is then used in a similarity search to retrieve a set of digital images from the enhanced vector database 220. FIG. 2 illustrates an example of a PERA retrieval result 230 based on the enhanced vector database 220. As shown, the PERA retrieval result 230 is a digital image. Specifically, the PERA retrieval result 230 displays a road with multiple lanes, trees, a sidewalk, and buildings. In addition, the PERA retrieval result 230 also displays a motorcycle 230A traveling in a lane and a car 230B in another lane. In this regard, the PERA retrieval result 230 is successful in retrieving and capturing objects of interest (e.g., motorcycle, car, etc.).

In contrast, the process, associated with comparative image retrieval, includes generating, via the image encoder, an image embedding 240 using pixels of the query image 200. The image embedding 240 is then directly used in a similarity search to retrieve a set of digital images from the vector database 250. FIG. 2 illustrates an example of a comparative retrieval result 260 based on the vector database 250. As shown, the comparative retrieval result 260 is a digital image. Specifically, the comparative retrieval result 260 displays a road with multiple lanes, trees, a sidewalk, and buildings. However, in contrast to the query image 200 and the PERA retrieval result 230, the comparative retrieval result 260 does not include a number of objects of interest (e.g., motorcycle, car, etc.). In this regard, the comparative retrieval result 260 misses a number of objects of interest. As such, the PERA retrieval result 230 is more similar to the query image 200 than the comparative retrieval result 260. The PERA retrieval result 230 thus provides better and more valuable results than the comparative retrieval result 260 when provided with the same query image 200.

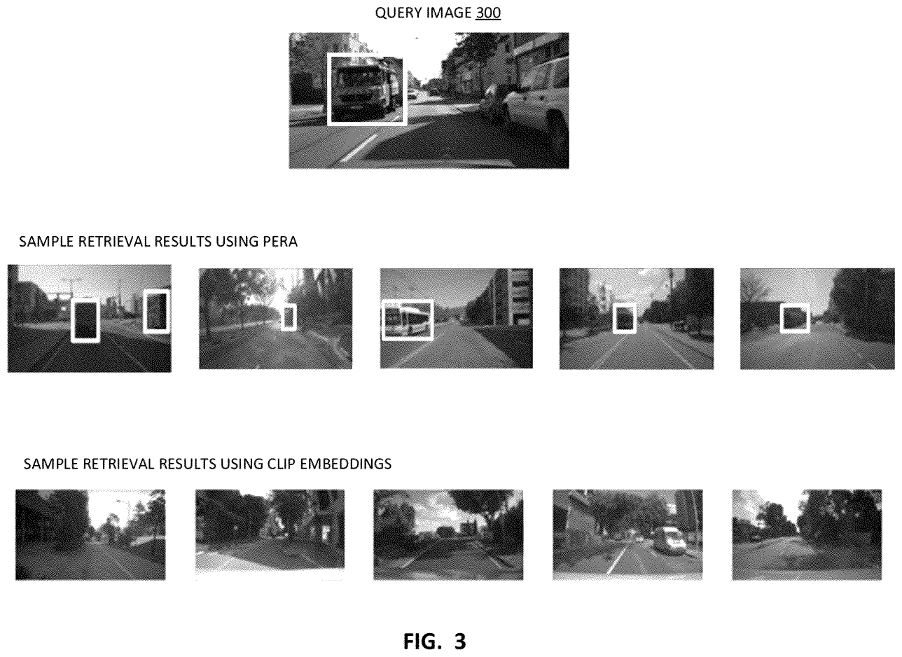

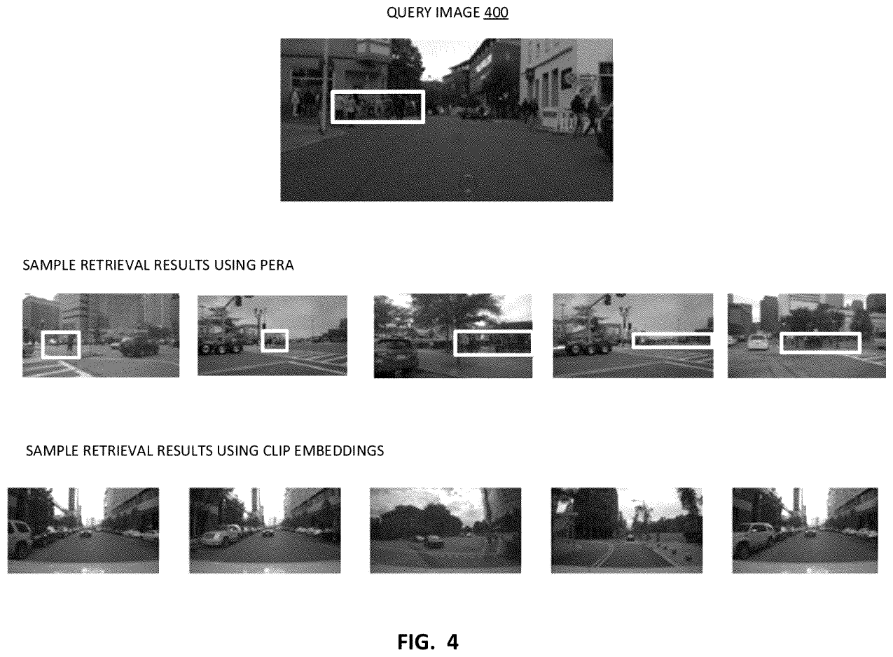

FIG. 3, FIG. 4, and FIG. 5 illustrate several examples of the retrieved images used for pre-training to highlight the benefits of PERA 100. In FIG. 3, FIG. 4, and FIG. 5, the top image is a query image from the Cityscapes dataset, while the other images show the top-5 retrieved images from the nulmages dataset using CLIP embeddings, both with PERA enhancement and without PERA enhancement. Firstly, PERA 100 yields a more diverse results compared to using CLIP embeddings alone. A closer examination reveals that images retrieved using only CLIP embeddings often overlook important objects. For instance, in a straightforward scenario (FIG. 3) where the query image 300 includes a large truck, none of the retrieved images using CLIP embeddings contain a large vehicle. Conversely, results using PERA often feature large vehicles, such as buses (e.g., boxes in FIG. 3), that even match the yellow color of the truck in the query image. In a more complex scenario (FIG. 4), the query image 400 includes multiple elements, such as a car, pedestrian, building, tree, and intersection. Here, the top 5 retrieved results using CLIP embeddings fail to include the pedestrian. This observation echoes that the complexity of embeddings can sometimes lead to overlooking important objects in the scene. Conversely, results using PERA include a number of pedestrians (e.g., boxes in FIG. 4). Furthermore, in scenarios with uncommon features, such as a query image 500 containing unique painted advertisements, PERA's results include images with similar advertisements (e.g. boxes in FIG. 5) on diverse vehicles like trucks, cruises, and buses, whereas CLIP's results lack this specificity and diversity. These enhancements in diversity and relevance with PERA not only improve its performance in pretraining but also enhance its efficacy in subsequent downstream tasks.

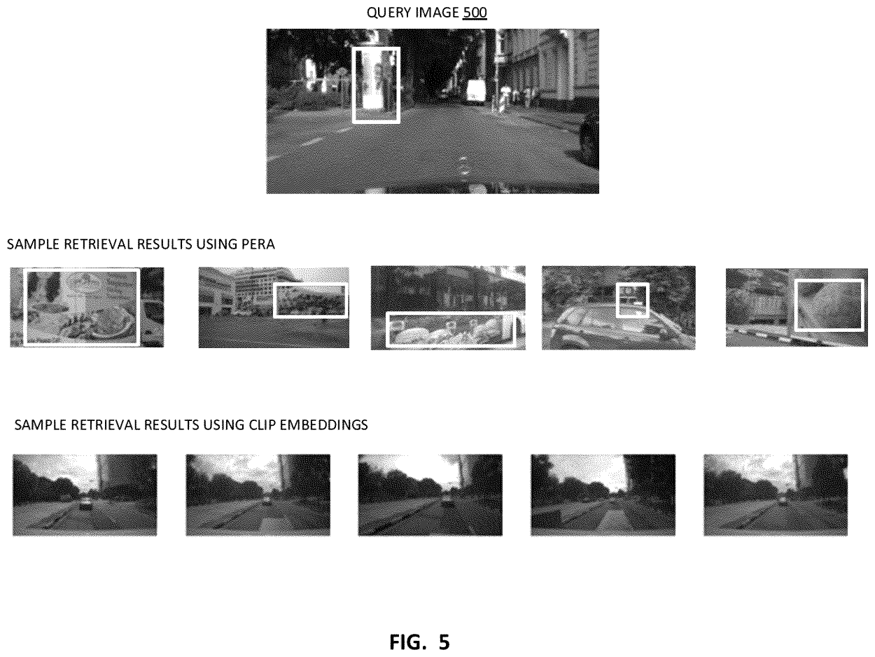

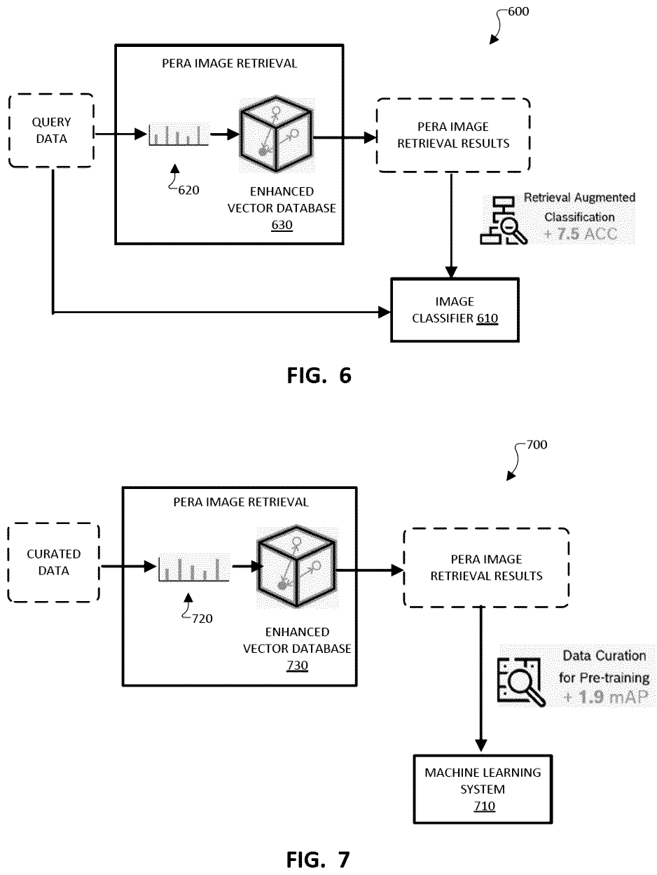

FIG. 6 illustrates a retrieval-based application using PERA image retrieval via an enhanced vector database 630. In particular, FIG. 6 illustrates an example of a process 600 of retrieval augmented generation/classification. The core concept involves retrieving relevant information from external knowledge sources to enhance a performance of a machine learning system, such as a classification model or a classifier. In computer vision, retrieval augmented classification has been used to address longtail challenges in classification.

As shown in FIG. 6, the process 600 involves training a more robust image classifier 610 by leveraging external knowledge, such as PERA 100. Specifically, in FIG. 6, PERA 100 generates weights 620 of the query data. The weights 620 are used in a similarity search to retrieve digital images from the enhanced vector database 630. The enhanced vector database 630 is generated via PERA 100, as discussed in FIG. 1, according to a specific task. Also, as shown in FIG. 6, the query data and the digital images from the PERA image retrieval results are used to train a machine learning system, such as image classifier 610. As a performance metric, experiments have shown that retrieval augmented classification with PERA 100 achieves +7.5 accuracy (ACC).

FIG. 7 illustrates another retrieval-based application using PERA image retrieval via an enhanced vector database 730. In particular, FIG. 7 illustrates an example of a process 700 of data curation for pretraining a machine learning system 710 (e.g., FM). Pretrained FMs have achieved significant performance gains across many tasks in the computer vision domain, mainly driven by large-scale pretraining datasets. However, raw web data can contain between 60% to 90% noisy or uninformative content, which wastes computational resources and potentially degrades final performance. To address these challenges, the process 700 of data curation involves starting with well-curated datasets.

As shown in FIG. 7, the process 700 involves pretraining a machine learning system 710 via PERA image retrieval results obtained from curated data. Specifically, in FIG. 7, PERA 100 generates weights 720 of the curated data. The weights 720 are used in a similarity search to retrieve digital images from the enhanced vector database 730. The enhanced vector database 730 is generated via PERA 100, as discussed in FIG. 1, according to a specific task. The process 700 includes utilizing only digital images from PERA image retrieval results for model pretraining. The PERA image retrieval results are then used for pretraining a machine learning system 710 to improve the performance of downstream tasks such as instance segmentation. Also, as a performance metric, experiments have shown that model pretraining is boosted for downstream instance segmentation tasks by as much as 1.0 mean Average Precision (mAP).

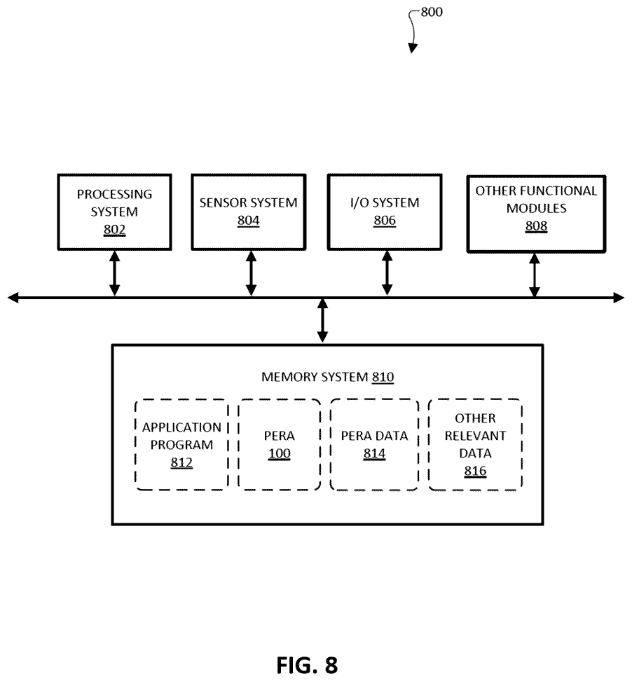

FIG. 8 illustrates an example of a system 800 that includes PERA 100 according to at least one example embodiment. The system 800 includes at least a processing system 802. The processing system 802 includes one or more processing devices. For example, the processing system 802 includes at least one or more GPUs. The processing system 802 may further include an electronic processor, a CPU, a microprocessor, a field-programmable gate array (FPGA), an application-specific integrated circuit (ASIC), any suitable processing technology, or any number and combination thereof. The processing system 802 is operable to provide the functionality as described herein.

The system 800 includes at least a memory system 810, which is operatively connected to the processing system 802. The memory system 810 is in data communication with the processing system 802. In an example embodiment, the memory system 810 includes at least one non-transitory computer readable medium, which is configured to store and provide access to various data to enable at least the processing system 802 to perform the operations and functionality, as disclosed herein. In an example embodiment, the memory system 810 comprises a single device or a plurality of devices. The memory system 810 can include electrical, electronic, magnetic, optical, semiconductor, electromagnetic, or any suitable storage technology that is operable with the system 800. For instance, in an example embodiment, the memory system 810 can include random access memory (RAM), read only memory (ROM), flash memory, a disk drive, a memory card, an optical storage device, a magnetic storage device, a memory module, any suitable type of memory device, or any combination thereof.

The memory system 810 includes at least PERA 100, an application program 812, various PERA data 814, and other relevant data 816, which are stored thereon. The memory system 810 includes computer readable data that, when executed by the processing system 802, is configured provide the functions and processes as described in the present disclosure. The computer readable data can include instructions, code, routines, various related data, any software technology, or any number and combination thereof. Specifically, the application program 812 includes computer readable data with instructions, which when executed by the processing system 802, is configured to provide an application platform for PERA 100 to operate with other components of the system 800 and interface with a user. Also, PERA 100 includes computer readable data with instructions, which when executed by the processing system 802, is configured to perform the process described in at least FIG. 1. PERA 100 also includes image encoder 110, vocabulary generator 120, task specific vocabulary 130, vector database 140, linear solver 150, and enhanced vector database 160, or some applicable combination/variation thereof. Also, the various PERA data 814 includes various image data, various image embedding data, various image identifiers (IDs), various weight data, various similarity calculation data, various parameter data, as well as any related PERA data (e.g., vector databases, enhanced vector databases, machine learning data, etc.) that enables the system 800 to perform the functions as disclosed in this disclosure. For example, the various training data includes at least various digital image/video data, etc. Meanwhile, the other relevant data 816 provides various data (e.g. operating system, etc.), which enables the system 800 to perform the functions as discussed herein.

In an example embodiment, as shown in FIG. 8, the system 800 is configured to include at least one sensor system 804. The sensor system 804 includes one or more sensors. For example, the sensor system 804 includes an image sensor or a camera, which is configured to capture digital images and/or digital video. The sensor system 804 may also include a radar sensor, a light detection and ranging (LIDAR) sensor, a thermal sensor, an ultrasonic sensor, an infrared sensor, a motion sensor, an audio sensor, an inertial measurement unit (IMU), any suitable sensor, or any combination thereof. The sensor system 804 is operable to communicate with one or more other components (e.g., processing system 802 and memory system 810) of the system 800. More specifically, for example, the processing system 802 is configured to obtain the sensor data directly or indirectly from at least one sensor. The sensor system 804 and/or the processing system 802 is configured to generate digital images and/or digital video. The processing system 802 is configured to process digital images and/or digital video in connection with PERA 100 and the various PERA data 814.

In addition, the system 800 includes other components that contribute to PERA 100. For example, as shown in FIG. 8, the memory system 810 is also configured to store other relevant data 816, which relates to operation of one or more components (e.g., sensor system 804, an input/output (I/O) system 806, and other functional modules 808). In addition, the I/O system 806 includes an I/O interface and may include one or more devices (e.g., display device, keyboard device, speaker device, etc.). Also, the system 800 includes other functional modules 808, such as any appropriate hardware technology, software technology, or combination thereof that assist with or contribute to the functioning of the system 800. For example, the other functional modules 808 include communication technology that enables components of the system 800 to communicate at least with each other, as described herein. The communication technology may enable the system 800 to communicate with other network devices (not shown) over a communication network. With at least the configuration discussed in the example of FIG. 8, the system 800 is configured to enable PERA 100 to perform the functions as discussed in this disclosure.

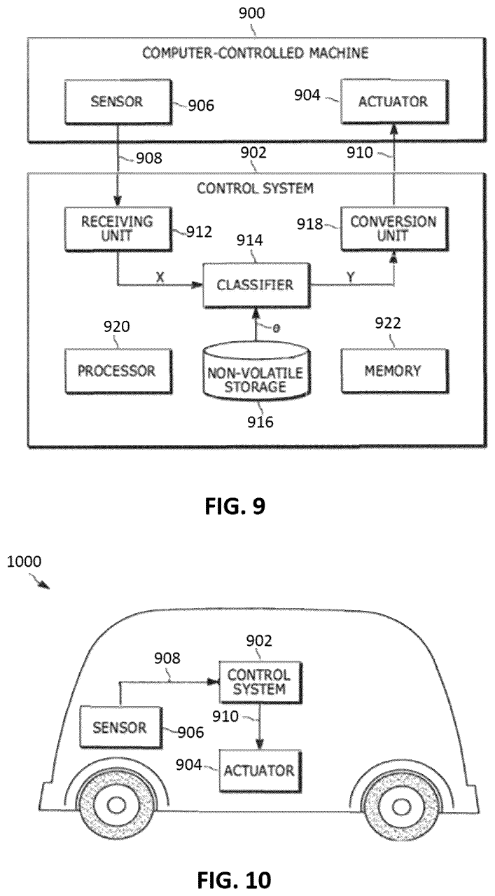

FIG. 9 depicts a schematic diagram of an interaction between computer-controlled machine 900 and control system 902. Computer-controlled machine 900 includes actuator 904 and sensor 906. Actuator 904 may include one or more actuators and sensor 906 may include one or more sensors. Sensor 906 is configured to sense a condition of computer-controlled machine 900. Sensor 906 may be configured to encode the sensed condition into sensor signals 908 and to transmit sensor signals 908 to control system 902. A non-limiting example of sensor 906 includes video, radar, LiDAR, an ultrasonic sensor, an image sensor, an audio sensor, a motion sensor, etc. In some embodiments, sensor 906 is an optical sensor configured to sense optical images of an environment proximate to computer-controlled machine 900.

Control system 902 is configured to receive sensor signals 908 from computer-controlled machine 900. As set forth below, control system 902 may be further configured to compute actuator control commands 910 depending on the sensor signals and to transmit actuator control commands 910 to actuator 904 of computer-controlled machine 900.

As shown in FIG. 9, control system 902 includes receiving unit 912. Receiving unit 912 may be configured to receive sensor signals 908 from sensor 906 and to transform sensor signals 908 into input signals x. In an alternative embodiment, sensor signals 908 are received directly as input signals x without receiving unit 912. Each input signal x may be a portion of each sensor signal 908. Receiving unit 912 may be configured to process each sensor signal 908 to product each input signal x. Input signal x may include data corresponding to an image recorded by sensor 906.

Control system 902 includes classifier 914 (e.g., image classifier 610), which is trained by a training dataset that includes at least a set of digital images retrieved via PERA 100. Classifier 914 may be configured to classify input signals x into one or more labels using a machine learning (ML) algorithm. Classifier 914 is configured to be parametrized by parameters, such as those described above (e.g., parameter θ). Parameters θ may be stored in and provided by non-volatile storage 916. Classifier 914 is configured to determine output signals y from input signals x. Each output signal y includes information that assigns one or more labels to each input signal x. Classifier 914 may transmit output signals y to conversion unit 918. Conversion unit 918 is configured to covert output signals y into actuator control commands 910. Control system 902 is configured to transmit actuator control commands 910 to actuator 904, which is configured to actuate computer-controlled machine 900 in response to actuator control commands 910. In some embodiments, actuator 904 is configured to actuate computer-controlled machine 900 based directly on output signals y.

Upon receipt of actuator control commands 910 by actuator 904, actuator 904 is configured to execute an action corresponding to the related actuator control command 910. Actuator 904 may include a control logic configured to transform actuator control commands 910 into a second actuator control command, which is utilized to control actuator 904. In one or more embodiments, actuator control commands 910 may be utilized to control a display instead of or in addition to an actuator.

In some embodiments, control system 902 includes sensor 906 instead of or in addition to computer-controlled machine 900 including sensor 906. Control system 902 may also include actuator 904 instead of or in addition to computer-controlled machine 900 including actuator 904. As shown in FIG. 9, control system 902 also includes processor 920 and memory 922. Processor 920 may include one or more processors. Memory 922 may include one or more memory devices. The classifier 914 of one or more embodiments may be implemented by control system 902, which includes non-volatile storage 916, processor 920, and memory 922.

Non-volatile storage 916 may include one or more persistent data storage devices such as a hard drive, optical drive, tape drive, non-volatile solid-state device, cloud storage or any other device capable of persistently storing information. Processor 920 may include one or more devices selected from high-performance computing (HPC) systems. Processor 920 may include one or more high-performance cores, graphics processing units, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 922. Memory 922 may include a single memory device or a number of memory devices including, but not limited to, RAM, volatile memory, non-volatile memory, static random access memory (SRAM), dynamic random access memory (DRAM), flash memory, cache memory, or any other device capable of storing information.

Processor 920 may be configured to read into memory 922 and execute computer-executable instructions residing in non-volatile storage 916 and embodying one or more ML algorithms and/or methodologies of one or more embodiments. Non-volatile storage 916 may include one or more operating systems and applications. Non-volatile storage 916 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 920, the computer-executable instructions of non-volatile storage 916 may cause control system 902 to implement one or more of the ML algorithms and/or methodologies to employ the classifier 914 as disclosed herein. Non-volatile storage 916 may also include ML data (including model parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments. Furthermore, the processes, methods, or algorithms can be embodied in whole or in part using suitable hardware components, such as ASICs, FPGAs, state machines, controllers or other hardware components or devices, or a combination of hardware, software and firmware components.

FIG. 10 depicts a schematic diagram of control system 902 configured to control vehicle 800, which may be at least a partially autonomous vehicle or a partially autonomous robot. Vehicle 1000 includes actuator 904 and sensor 906. Sensor 906 may include one or more video sensors, cameras, radar sensors, ultrasonic sensors, LiDAR sensors, and/or position sensors (e.g. Global Positioning System). One or more of the one or more specific sensors may be integrated into vehicle 1000. Alternatively or in addition to one or more specific sensors identified above, sensor 906 may include a software module configured to, upon execution, determine a state of actuator 904. One non-limiting example of a software module includes a weather information software module configured to determine a present or future state of the weather proximate to the vehicle 1000 or at another location.

Classifier 914 of control system 902 of vehicle 1000 may be configured to detect objects in the vicinity of vehicle 1000 dependent on input signals x. In such an embodiment, output signal y may include information classifying or characterizing objects in a vicinity of the vehicle 1000. Actuator control command 910 may be determined in accordance with this information. The actuator control command 910 may be used to avoid collisions with the detected objects.

In some embodiments, the vehicle 1000 is an at least partially autonomous vehicle or a fully autonomous vehicle. The actuator 904 may be embodied in a brake, a propulsion system, an engine, a drivetrain, a steering of vehicle 1000, etc. Actuator control commands 910 may be determined such that actuator 904 is controlled such that vehicle 1000 avoids collisions with detected objects. Detected objects may also be classified according to what classifier 914 deems them most likely to be, such as pedestrians, trees, any suitable labels, etc. The actuator control commands 910 may be determined depending on the classification.

In some embodiments where vehicle 1000 is at least a partially autonomous robot, vehicle 1000 may be a mobile robot that is configured to carry out one or more functions, such as flying, swimming, diving and stepping. The mobile robot may be a lawn mower, which is at least partially autonomous, or a cleaning robot, which is at least partially autonomous. In such embodiments, the actuator control command 910 may be determined such that a propulsion unit, steering unit and/or brake unit of the mobile robot may be controlled such that the mobile robot may avoid collisions with identified objects.

In some embodiments, vehicle 1000 is an at least partially autonomous robot in the form of a gardening robot. In such embodiment, vehicle 1000 may use an optical sensor as sensor 906 to determine a state of plants in an environment proximate to vehicle 1000. Actuator 904 may be a nozzle configured to spray chemicals. Depending on an identified species and/or an identified state of the plants, actuator control command 910 may be determined to cause actuator 904 to spray the plants with a suitable quantity of suitable chemicals.

Vehicle 1000 may be a robot, which is at least partially autonomous and in the form of a domestic appliance. As a non-limiting example, a domestic appliance may include a washing machine, a stove, an oven, a microwave, a dishwasher, etc. In such a vehicle 1000, sensor 906 may be an optical sensor configured to detect a state of an object which is to undergo processing by the household appliance. For example, in the case of the domestic appliance being a washing machine, sensor 906 may detect a state of the laundry inside the washing machine. Actuator control command 910 may be determined based on the detected state of the laundry.

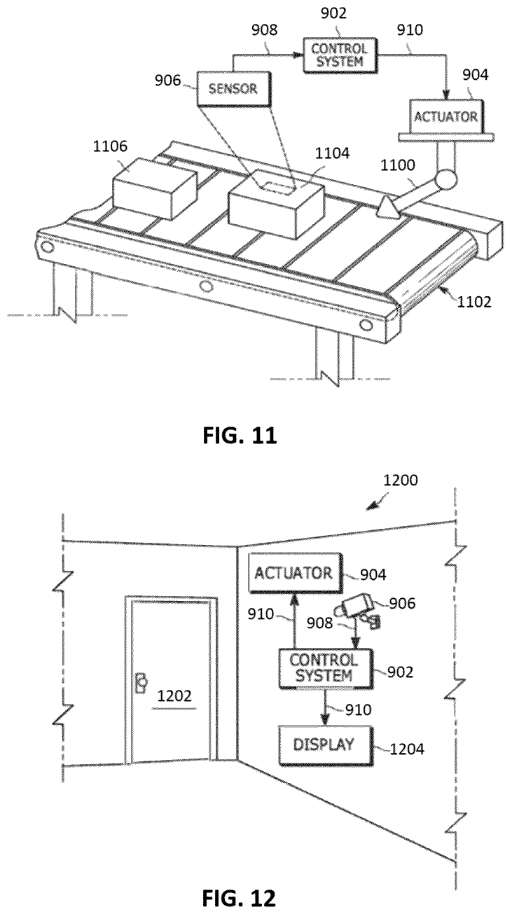

FIG. 11 depicts a schematic diagram of control system 902 configured to control a system 1100 (e.g., manufacturing machine), which may include a punch cutter, a cutter, a gun drill, or the like, of a manufacturing system 1102, such as part of a production line. Control system 902 may be configured to control actuator 904, which is configured to control the system 1100 (e.g., manufacturing machine).

Sensor 906 of the system 1100 (e.g., manufacturing machine) may be an optical sensor configured to capture one or more properties of a manufactured product 1104. Classifier 914 may be configured to determine a state of manufactured product 1104 from one or more of the captured properties. Actuator 904 may be configured to control the system 1100 (e.g., manufacturing machine) depending on the determined state of a manufactured product 1104 for a subsequent manufacturing step of the manufactured product 1104. The actuator 904 may be configured to control functions of the system 1100 (e.g., manufacturing machine) on a subsequent manufactured product 1106 of system 1100 (e.g., manufacturing machine) depending on the determined state of manufactured product 1104.

FIG. 12 depicts a schematic diagram of control system 902 configured to control monitoring system 1200. Monitoring system 1200 may be configured to physically control access through door 1202. Sensor 906 may be configured to detect a scene that is relevant in deciding whether access is granted. Sensor 906 may be an optical sensor configured to generate and transmit image and/or video data. Such data may be used by control system 902 to detect a person's face.

Classifier 914 of control system 902 of monitoring system 1200 may be configured to interpret the image and/or video data by matching identities of known people stored in non-volatile storage 916, thereby determining an identity of a person. Classifier 914 may be configured to generate an actuator control command 910 in response to the interpretation of the image and/or video data. Control system 902 is configured to transmit the actuator control command 910 to actuator 904. In this embodiment, the actuator 904 is configured to lock or unlock door 1202 in response to the actuator control command 910. In some embodiments, a non-physical, logical access control is also possible.

Monitoring system 1200 may also be a surveillance system. In such an embodiment, sensor 906 may be an optical sensor configured to detect a scene that is under surveillance and the control system 902 is configured to control display 1204. Classifier 914 is configured to determine a classification of a scene, e.g. whether the scene detected by sensor 906 is suspicious. Control system 902 is configured to transmit an actuator control command 910 to display 1204 in response to the classification. Display 1204 may be configured to adjust the displayed content in response to the actuator control command 910. For instance, display 1204 may highlight an object that is deemed suspicious by classifier 914.

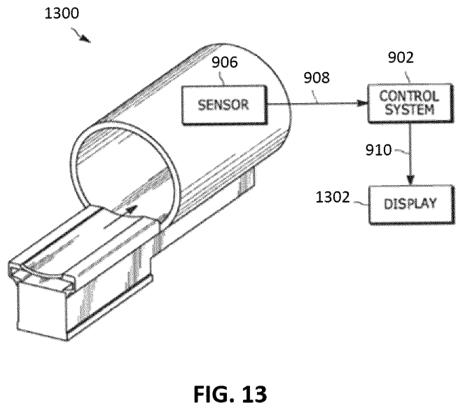

FIG. 13 depicts a schematic diagram of control system 902 configured to control imaging system 1300, for example a magnetic resonance imaging (MRI) apparatus, x-ray imaging apparatus or ultrasonic apparatus. Sensor 906 may, for example, be an imaging sensor. Classifier 914 may be configured to determine a classification of all or part of the sensed image. Classifier 914 may be configured to determine or select an actuator control command 910 in response to the classification obtained by the trained neural network. For example, classifier 914 may interpret a region of a sensed image to be potentially anomalous. In this case, the actuator control command 910 may be selected to cause display 1302 to display the image and highlight the potentially anomalous region.

As described in this disclosure, the embodiments include a number of advantageous features, as well as benefits. For example, the embodiments find a technical solution to the following problem: “Is it possible to enhance the precomputed embeddings in vector databases to improve the performance of retrieval-based applications without recomputing application-specific embeddings?” To solve this problem, the embodiments include PERA 100, which provides a novel approach of decomposing the precomputed embeddings into a linear combination of embeddings tailored to the downstream application (e.g., embeddings of foreground objects in images). In this regard, PERA 100 addresses the challenge of improving precomputed embeddings in vector databases for downstream retrieval applications without recomputing application-specific embeddings. PERA 100 decomposes precomputed embeddings into a linear combination of embeddings tailored to specific applications, thereby enhancing performance in an efficient manner. In this regard, PERA 100 enhances re-computed embeddings by decomposing them into a linear combination of embeddings that meet the requirements of the target retrieval application. In this regard, PERA 100 relates to enhancing embeddings in vector databases for downstream retrieval applications without the need to recompute embeddings from the original dataset. Also, PERA 100 is computationally efficient and doesn't use the original dataset.

In addition, PERA 100 has demonstrated significant improvements across various retrieval applications, confirming its usefulness and effectiveness. Experimental results demonstrate that PERA 100 significantly improves retrieval performance across various applications. Specifically, PERA 100 elevates instance search performance by up to 23.1 mean Average Precision (mAP), enhances retrieval augmented classification accuracy by up to 7.5%, and boosts model pre-training for the downstream instance segmentation task by as much as 1.9 mAP.

Furthermore, the above description is intended to be illustrative, and not restrictive, and provided in the context of a particular application and its requirements. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the general principles defined herein may be applied to other embodiments and applications without departing from the spirit and scope of the described embodiments, and the true scope of the embodiments and/or methods of the present invention are not limited to the embodiments shown and described, since various modifications will become apparent to the skilled practitioner upon a study of the drawings, specification, and following claims. Additionally, or alternatively, components and functionality may be separated or combined differently than in the manner of the various described embodiments and may be described using different terminology. These and other variations, modifications, additions, and improvements may fall within the scope of the disclosure as defined in the claims that follow.

1. A computer-implemented method for digital image retrieval comprising:
generating a vocabulary of visual concepts for a specific task using a target dataset, the vocabulary including a representative image embedding or a representative patch embedding for each visual concept;
retrieving precomputed image embeddings from a vector database;
decomposing each precomputed image embedding into a linear combination of the visual concepts;
generating a set of weights for each precomputed image embedding based on the vocabulary, each weight indicating a prominence of a respective representative image embedding or a respective representative patch embedding;
storing the set of weights for each precomputed image embedding in an enhanced vector database; and
retrieving a set of digital images in response to a query using the enhanced vector database.

2. The computer-implemented method of claim 1, wherein each linear combination of the visual concepts includes nonnegative and sparse weights.

3. The computer-implemented method of claim 1, further comprising:
implementing an Alternating Direction Method of Multipliers (ADMM) algorithm, via graphics processing unit (GPU), to perform the step of decomposing each precomputed image embedding.

4. The computer-implemented method of claim 1, further comprising:
receiving another digital image as the query;
generating, via an image encoder, another image embedding using pixels of the another digital image;
decomposing the another image embedding into another linear combination of the visual concepts;
generating a query set of weights for the query based on the vocabulary;
performing a similarity search on the enhanced vector database using the query set of weights.

5. The computer-implemented method of claim 1, wherein the similarity search is performed by employing a Dice Coefficient.

6. The computer-implemented method of claim 1, further comprising:
receiving the target dataset that includes target images for the specific task;
generating, via an image encoder, target image embeddings or target patch embeddings using pixels of the target images;
selecting the representative image embedding or the representative patch embedding for each visual concept; and
building the vocabulary to include each representative image embedding or each representative patch embedding of each cluster.

7. The computer-implemented method of claim 6, further comprising:
clustering the target image embeddings or the target patch embeddings into clusters;
and
computing a centroid for each cluster of target image embeddings or target patch embeddings,
wherein each centroid is selected as being the representative image of each cluster.

8. The computer-implemented method of claim 1, further comprising:
receiving the target dataset that includes target images; and
generating patches of each target image,
wherein the target image embeddings are generated using the patches.

9. The computer-implemented method of claim 1, further comprising:
storing image identifiers corresponding to each set of weights in the enhanced vector database,
wherein the set of digital images is retrieved using a corresponding set of image identifiers upon performing a similarity search on the enhanced vector database using the query set of weights.

10. The computer-implemented method of claim 1, further comprising:
generating a training dataset that includes the set of retrieved images; and
training a machine learning model to perform the specific task using the training dataset.

11. A system comprising:
one or more processors;
one or more computer memory in data communication with the one or more processors, the one or more computer memory having computer readable data stored thereon, the computer readable data including instructions that, when executed by one or more processors, causes the one or more processors to perform a method for digital image retrieval, the method including
generating a vocabulary of visual concepts for a specific task using a target dataset, the vocabulary including a representative image embedding or a representative patch embedding for each visual concept;
retrieving precomputed image embeddings from a vector database;
decomposing each precomputed image embedding into a linear combination of the visual concepts;
generating a set of weights for each precomputed image embedding based on the vocabulary, each weight indicating a prominence of a respective representative image embedding or a respective representative patch embedding;
storing the set of weights for each precomputed image embedding in an enhanced vector database; and
retrieving a set of digital images in response to a query using the enhanced vector database.

12. The system of claim 11, wherein each linear combination of the visual concepts includes nonnegative and sparse weights.

13. The system of claim 11, wherein:
the one or more processors includes a graphics processing unit (GPU); and
an Alternating Direction Method of Multipliers (ADMM) algorithm is implemented, via the GPU, to perform the step of decomposing each precomputed image embedding.

14. The system of claim 11, wherein the method further comprises:
receiving another digital image as the query;
generating, via an image encoder, another image embedding using pixels of the another digital image;
decomposing the another image embedding into another linear combination of the visual concepts;
generating a query set of weights for the query based on the vocabulary; and
performing a similarity search on the enhanced vector database using the query set of weights.

15. The system of claim 11, wherein the similarity search is performed by employing a Dice Coefficient.

16. The system of claim 11, wherein the method further comprises:
receiving the target dataset that includes target images for the specific task;
generating, via an image encoder, target image embeddings or target patch embeddings using pixels of the target images;
selecting the representative image embedding or the representative patch embedding for each visual concept; and
building the vocabulary to include each representative image embedding or each representative patch embedding of each cluster.

17. The system of claim 16, wherein the method further comprises:
clustering the target image embeddings into clusters or the target patch embeddings;
and
computing a centroid for each cluster of target image embeddings or target patch embeddings,
wherein each centroid is selected as being the representative image of each cluster.

18. The system of claim 11, wherein the method further comprises:
receiving the target dataset that includes target images; and
generating patches of each target image,
wherein the target image embeddings are generated using the patches.

19. The system of claim 11, wherein the method further comprises:
storing image identifiers corresponding to each set of weights in the enhanced vector database,
wherein the set of digital images is retrieved using a corresponding set of image identifiers upon performing a similarity search on the enhanced vector database using the query set of weights.

20. The system of claim 11, wherein the method further comprises:
generating a training dataset that includes the set of retrieved images; and
training a machine learning model to perform the specific task using the training dataset.
